(19) United States
(12) Patent Application Publication
(10) Pub. No.: US 2004/0009034 A1
(43) Pub. Date: Jan. 15, 2004

(54) Fastening device for an aiming telescope on a weapon

(75) Inventor: Benno Miller, Innsbruck (AT)

Correspondence Address: Mark Ungerman, Fulbright & Jaworski, LLP, 801 Pennsylvania Avenue, N.W., Washington, DC, 20004, US

(73) Assignee: Swarovski Optik K.G., Tirol (AT)

(21) Appl. No.: 10/443,993

(22) Filed: May 23, 2003

(30) Foreign Application Priority Data
Jul. 9, 2002 (EP) EP 02 015 263.3

(51) Int. Cl. F16D 1/00

(52) U.S. Cl. 403/363

(57) ABSTRACT

A fastening device for attaching an aiming telescope (1) on a weapon using a mounting rail (2) connected to a telescope housing and extending along the telescope, the mounting rail being supported on at least one mounting apparatus (3a, 3b) fastened to the weapon. The mounting rail is provided with a longitudinal groove (5) and a clamping part (7) corresponding to an inside profile of the longitudinal groove (5) is inserted into the groove and fixed with an attaching screw (8) that engages threads (9) in the clamping part (7). The attaching screw (8) is passed through an opening (11a, 11b) in the mounting apparatus (3a, 3b). The mounting rail (2) is provided on the side facing the mounting apparatus (3a, 3b) with a toothing (22) that is engaged by at least one projection (23) protruding from the mounting apparatus.

### BACKGROUND OF THE INVENTION

1. Field of the Invention

The present invention relates to a device for fastening an aiming telescope on a weapon. More particularly, the present invention relates to a fastening device having a mounting rail for connection to a telescope housing and extending along a length of the telescope. The mounting rail being supported on at least one mounting apparatus that is fastened to the weapon, and the mounting rail having a longitudinal groove for insertion of a clamping part corresponding to the inside profile of the groove so the clamping part can be fixed with an attaching screw engaging a thread in the clamping part through an opening in the mounting apparatus.

2. Description of the Related Technology

An apparatus for fastening an aiming telescope on a weapon must ensure exact and stable connection of the aiming telescope on the weapon so that the line of sight does not change despite shock loads produced by weapon recoil.

Further, aiming telescopes should be easily fastenable to and detachable from a mounting apparatus. The aiming telescope must also not be damaged by the connection. Moreover, lightweight, and low profile construction are required. Finally, the aiming telescope should be fastenable in axially different positions relative to the mounting apparatus.

It is known to provide the aiming telescope with a mounting rail of dovetailed cross section so as to attach a mounting apparatus on the weapon with clamping jaws, and to clamp the mounting rail between the clamping jaws with a clamping screw penetrating the clamping jaws and at a cross bore in the mounting rail.

However, such arrangements require bores to be made during mounting of the aiming telescope that lead to damage and thus depreciation of the telescope. Also, the bores involve increased expenditure of labor. Moreover, the dovetailed mounting rail must have a considerable overall height to permit the bores to be made, which results in increased weight of the mounting rail and thus the aiming telescope.

Further, DE 38 20 471 C2 discloses a fastening apparatus of the type stated at the outset. A wedge-shaped mounting rail is drawn firmly into a wedge-shaped groove in a mounting apparatus with a clamping part when an attaching screw is tightened. Even slight loosening of the attaching or clamping screw leads to detachment of the connection and thus maladjustment between aiming telescope and weapon. Since weapon firing forces are absorbed only by frictional forces, high clamping forces are moreover required. So that the mounting rail is not deformed by high clamping forces, the mounting apparatus must be of solid design in the area of the guide groove, which causes increased weight.

### SUMMARY OF THE INVENTION

An object of the present invention is to provide a low profile and lightweight device for precise and stable connection of an aiming telescope to a weapon with a mounting apparatus.

According to an embodiment for the present invention, a fastening device including a mounting rail is connected to and extends along an aiming telescope housing. The mounting rail being supported on at least one mounting apparatus fastened to the weapon, and the mounting rail having a longitudinal groove for insertion of a clamping part that can be fixedly attached using a screw passed through an opening in the mounting rail. Furthermore, the mounting rail includes a set of teeth on the side facing the mounting apparatus. These teeth are engaged by at least one projection extending from the mounting apparatus. The set of teeth or toothing extending from the mounting rail and engaged by a projection from the mounting apparatus ensure that axial forces acting on the aiming telescope are positively absorbed.

Preferably, the clamping part extends into an opening in the mounting apparatus. Thus, the clamping part is longer than the overall height of the inside profile of the mounting rail. This arrangement guarantees that there can be a low overall height of the mounting rail. Moreover, the mounting rail is formed with a groove or hollow section, which additionally reduces the weight of the mounted aiming telescope. Also, the clamping part extends into the opening in the mounting apparatus to ensure sufficient thread length and thus a very reliable screw interconnection.

Due to a positive fit (i.e., a close tolerance and continuous fit but not a forced fit between attaching parts and surrounding parts) the attaching screws are not overly stressed by weapon firing forces so there is little danger of the screws loosening.

The clamping part preferably rests in a positive fit with its outside circumference adjacent sides of an opening into the longitudinal groove in the mounting rail and also adjacent the surface of the opening in the mounting apparatus. This positive fit connection provides a tight lateral guidance between the mounting rail and the clamping part. Thus, lateral forces occurring during firing are reliably absorbed and the danger of misadjustment of the aiming telescope is eliminated.

Furthermore, no massive lateral shoulders are required on the mounting apparatus. Rather, the mounting rail can be supported on the mounting apparatus from a flat surface. Thus, the mounting apparatus can be formed quite light. Also, the sides of the mounting rail remain largely free and smooth so they can be adapted to the appearance of the aiming telescope.

According to the present invention, the fastening of the aiming telescope is effected without damaging the aiming telescope or actually having to damage it. A simple tool, such as a screwdriver, suffices for fastening the aiming telescope to the mounting apparatus.

Instead of a flat surface, the mounting apparatus also can have on the side facing the mounting rail, for absorbing lateral forces, a flat longitudinal groove with a rectangular cross section. For example, the flat longitudinal groove in the mounting apparatus can be engaged in a positive fit by an accordingly rectangular flat projection extending from the mounting rail.

Moreover, the mounting apparatus can be provided with an insert into which the clamping part can extend. The insert and mounting apparatus can be made of different materials, for example steel and aluminum. Such construction allows for a further weight saving.

### BRIEF DESCRIPTION OF THE DRAWINGS

In the following enabling disclosure the present invention will be explained in more detail by way of example with reference to the enclosed drawings, in which:

FIG. 1 shows a longitudinal partial sectional view through a part of an aiming telescope and a first embodiment of a device for fastening the aiming telescope to a weapon (not shown);

FIGS. 2 and 3 show cross sectional views along lines II-II and III-III according to FIG. 1 of the aiming telescope and device for fastening;

FIG. 4 shows a cross sectional view through the aiming telescope according to FIGS. 1-3 without a mounting apparatus;

FIG. 5 shows a partial plan bottom view of the aiming telescope shown in FIG. 1;

FIG. 6 shows a plan bottom view of a clamping part shown in FIG. 1;

FIG. 7 shows a cross sectional view through the clamping part along line VII-VII shown in FIG. 6;

FIG. 8 shows a longitudinal partial sectional view through a part of an aiming telescope and a device for fastening the aiming telescope to a weapon according to another embodiment of the present invention;

FIG. 9 shows a cross sectional view along line IX-IX according to FIG. 8 of the telescope and device for fastening;

FIG. 10 shows a longitudinal sectional view through a part of an aiming telescope and a device for fastening the aiming telescope to a weapon according to a further embodiment of the present invention;

FIG. 11 shows a cross sectional view along line XI-XI according to FIG. 10 of the aiming telescope and device for fastening;

FIG. 12 shows a plan side view of the insert of the fastening device according to FIGS. 10 and 11; and

FIG. 13 shows a protective cover for the groove in the mounting rail that extends from the aiming telescope.

### DETAILED DESCRIPTION

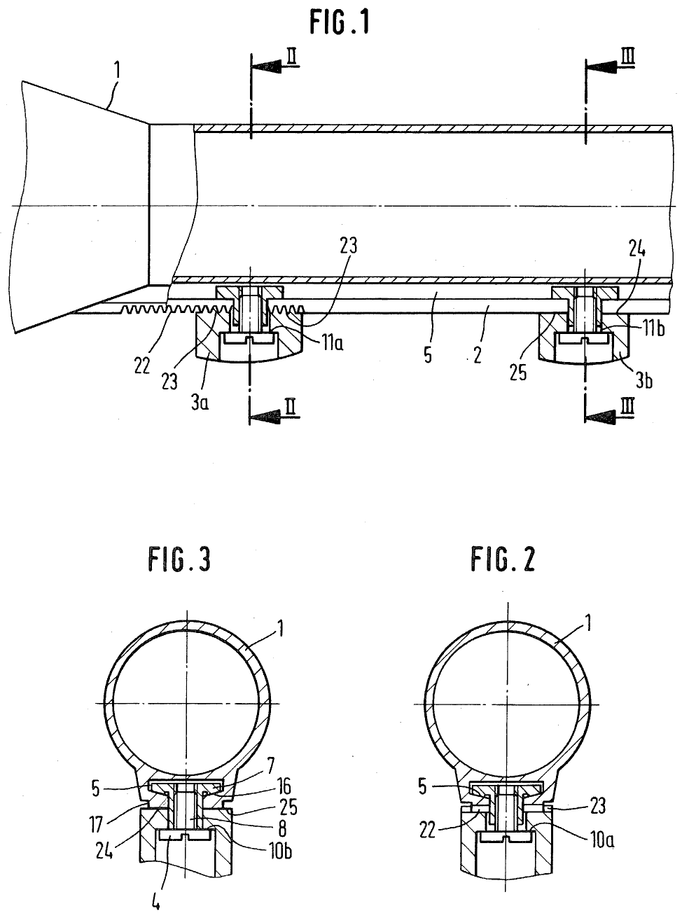

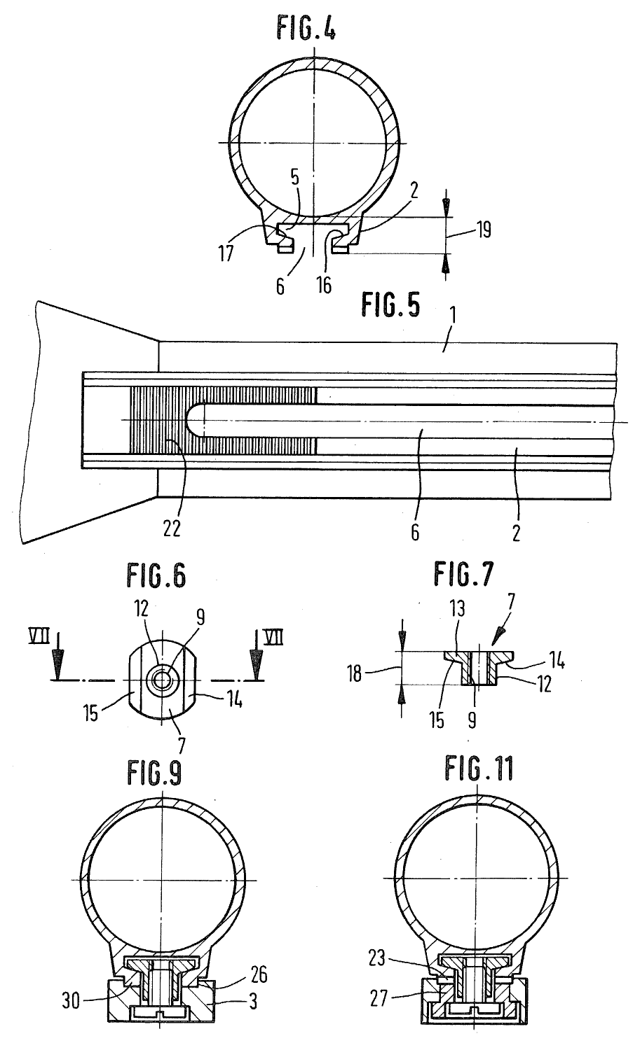

According to FIGS. 1 to 7, an aiming telescope 1 has an included mounting rail 2 extending at least over part of the length of the aiming telescope 1. Supported from mounting rail 2 are two bearings or mounting apparatuses 3a, 3b that are spaced apart to be fastened to a weapon (not shown). Mounting rail 2 is formed as having a hollow structure, i.e. it has a longitudinal groove 5 with a longitudinal opening 6 (FIG. 4). A clamping part 7 is inserted into longitudinal groove 5 as shown in FIG. 3. To permit clamping part 7 to be inserted into groove 5, opening 6 has a large enough cross section at one end (not shown) to accept entrance of clamping part 7.

Clamping part 7 is provided with internal threads 9 that are engaged by attaching screw 8. Clamping parts 7 protrude through openings 11a, 11b and into mounting apparatuses 3a, 3b. With their heads 4, screws 8 are supported on inside shoulders 10a, 10b in mounting apparatuses 3a, 3b (see FIGS. 2 and 3).

Clamping parts 7 extend into openings 11a, 11b of mounting apparatuses 3a, 3b. Clamping parts 7 thus are formed with a T-shaped cross section. The vertical bar of the T-shaped cross section is constituted by sleeve-shaped portion 12, while the crossbar of the T-shaped cross section is constituted by head 13 having on its underside on both sides of portion 12 clamping surfaces 14, 15 that are thicker in a wedge shape toward portion 12 (FIGS. 6 and 7) and that cooperate with accordingly inclined clamping surfaces 16, 17 in longitudinal groove 5 on both sides of longitudinal opening 6.

A bore with internal threads 9 extends through sleeve-shaped portion 12 and head 13. Sleeve-shaped portions 12 of clamping parts 7 extend through longitudinal opening 6 in mounting rail 2 and into openings 11a, 11b of the two mounting apparatuses 3a, 3b. Clamping part 7 thus has overall height 18 (FIG. 7) that is substantially greater than the overall height of the inside profile of longitudinal groove 5. Thus, mounting rail 2 can have small overall height 19 (FIG. 4). Sleeve-shaped portion 12 of clamping part 7 rests with its outside circumference having a positive fit in contact with both sides of walls of opening 6 of longitudinal groove 5, and its outside circumference further rests in a close tolerance and continuous fit, i.e., a positive fit, against the walls of openings 11a, 11b of mounting apparatuses 3a, 3b.

Mounting rail 2 at one end is provided on both sides of longitudinal opening 6 with a set of teeth or toothing 22 on the side facing mounting apparatus 3a and in the area where mounting apparatus 3a is to be attached to mounting rail 2. Mounting apparatus 3a in turn has on the side facing mounting rail 2 projections forming teeth 23 (FIG. 1) that extend along the longitudinal direction of aiming telescope 1 for engaging toothing 22 on mounting rail 2. Teeth 23 and the teeth of toothing 22 can be, for example, of trapezoidal, rectangular or other appropriate form. In contrast, mounting rail 2 is supported in the area of the other mounting apparatus 3b with flat surface 24 resting on flat surface 25 of mounting apparatus 3b (FIGS. 1 and 3).

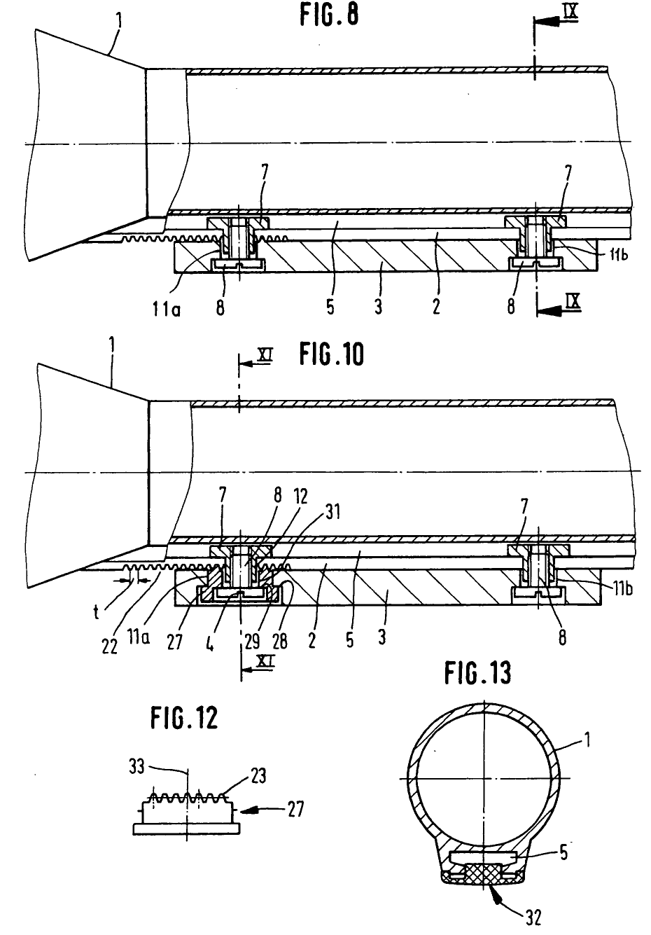

The embodiment of the present invention according to FIGS. 8 and 9 substantially differs from that according to FIGS. 1-7 in that mounting apparatus 3 is formed as a one-piece rail having on the side facing mounting rail 2 flat longitudinal groove 26 of rectangular cross section that is engaged in a positive fit by projection 30 of rectangular cross section that extends from mounting rail 2. Mounting apparatus 3 extends along the weapon (not shown) and is provided with openings 11a, 11b through which attaching screws 8 extend into clamping part 7 in each case.

According to FIGS. 10, 11 and 12, insert 27 is provided in conjunction with mounting apparatus 3 at one opening 11a, the insert 27 being shown separately in FIG. 12. Insert 27, as shown, is provided with teeth 23 (FIG. 12) that engage toothing 22 (FIG. 10) which extend from mounting rail 2 of telescope 1.

Insert 27 is of T-shaped cross section, the vertical bar of the T-shaped cross section constitutes the portion with which insert 27 protrudes through opening 11a in mounting apparatus 3; it also is provided with teeth 23 that engage toothing 22. In contrast, the crossbar of the T-shaped cross section of insert 27 is supported on inside shoulder 28 (FIG. 10) in mounting apparatus 3 at the end of opening 11a facing away from mounting rail 2.

Further, insert 27 in turn has inside shoulder 29 on which head 4 of screw 8 is supported. Finally, insert 27 has inside recess 31 (FIG. 10) into which sleeve-shaped portion 12 of clamping part 7 extends. Teeth 23 can be offset by one quarter pitch “t” of toothing 22 from cylinder axis 33 of insert 27 in overall respect to mounting apparatus 3 as shown in FIGS. 10 and 11. Accordingly, the axial length of the aiming telescope can be fixed precisely at one half pitch “t” relative to mounting apparatus 3 depending on the mounting position of insert 27.

As shown in FIG. 13, opening 6 into groove 5 of mounting rail 2 can be closed with a cover 32 along the areas of opening 6 that are not covered by mounting apparatuses 3a, 3b. The cover 32 has a T-shaped cross section with the vertical bar of the T-shaped cross section extending into the longitudinal groove 5 of mounting rail 2; while the crossbar of the T-shaped cross section is positioned to be engaged over the outside of mounting rail 2 that faces mounting apparatus 3, 3a, 3b when telescope 1 is mounted. Cover 32 protects longitudinal groove 5 from dirt and soiling. Also, the appearance of telescope 1 is improved by covering 32. Cover 32 is preferably made of an easily cuttable material. Thus, the required length of cover 32 can be adapted to any particular mounting in a simple way.

What is claimed is:

1. A fastening device for an aiming telescope on a weapon having a mounting rail connected with the telescope housing and extending along the telescope, said rail being supported on at least one mounting apparatus fastened to the weapon and having a longitudinal groove for insertion of a clamping part corresponding to the inside profile of the groove and fixed with an attaching screw engaging a thread in the clamping part through an opening in the mounting apparatus, characterized in that the mounting (2) provided on the side facing the mounting apparatus (3, 3a, 3b) with a toothing (22) that is engaged by at least one projection (23) connected with the mounting apparatus (3, 3a, 3b).

2. A fastening device according to claim 1, characterized in that the clamping part (7) extends into the opening (11a, 11b) in the mounting apparatus (3, 3a, 3b).

3. A fastening device according to claim 1 or 2, characterized in that the clamping part (7) is formed in a positive fit both with the opening (6) of the longitudinal groove (5) of the mounting rail (2) and with the opening (11a, 11b) in the mounting apparatus (3, 3a, 3b).

4. A fastening device according to any of the above claims, characterized in that the clamping part (7) is of T-shaped form, the vertical bar of the T constituting a sleeve-shaped portion (12) through which the internal thread extends for the attaching screw (8), while the crossbar of the T has clamping surfaces (14, 15) on its underside on both sides of the vertical bar for cooperating with clamping surfaces (16, 17) of the inside profile of the groove (5) of the mounting rail (2).

5. A fastening device according to claim 4, characterized in that the sleeve-shaped portion (12) protrudes into the opening (11a, 11b) of the mounting apparatus (3, 3a, 3b).

6. A fastening device according to claim 4 or 5, characterized in that the sleeve-shaped portion (12) is formed in a positive fit both with the opening (6) of the longitudinal groove (5) of the mounting rail (2) and with the opening (11a, 11b) in the mounting apparatus (3, 3a, 3b).

7. A fastening device according to any of the above claims, characterized in that the mounting apparatus (3, 3a,; 3b) has a longitudinal groove (26) that is engaged in a positive fit by a projection (30) extending along the mounting rail (2).

8. A fastening device according to claim 7, characterized in that the groove (26) and the projection (30) are of rectangular form.

9. A fastening device according to claim 1, characterized in that the at least one projection (23) engaging the toothing (22) of the mounting rail (2) is provided on an insert (27).

10. A fastening device according to claim 9, characterized in that the insert (27) has an outside circumference in positive fit with the opening (11a) of the mounting apparatus (3).

11. A fastening device according to claim 9 or 10, characterized in that the insert (27) is of T-shaped form, the vertical bar of the T constituting the portion with which the insert (27) protrudes through the opening (11a) in the mounting apparatus (3), while the crossbar of the T is supported on an inside shoulder (28) at the end of the opening (11a) in the mounting apparatus (3) facing away from the mounting rail (2).

12. A fastening device according to any of claims 9-11, characterized in that the clamping part (7) extends into the insert (27) in the mounting apparatus (3).

13. A fastening device according to any of the above claims, characterized in that the mounting apparatus (3) is formed as a rail having at least two openings (11a, 11b) each receiving an attaching screw (8) that engages a clamping part (7) in the longitudinal groove (5) of the mounting rail (2).
